(19) United States
(12) Patent Application Publication
(10) Pub. No.: US 2013/0195308 A1
(43) Pub. Date: Aug. 1, 2013

(54) EAR WARMER

(71) Applicants: Amy TANKERSLEY, Baltimore, MD (US); Paul REEDER, Worthington, OH (US); Erika BRAUN, Columbus, OH (US); George CAMPBELL, San Pedro, CA (US); Jennifer GOFF, Williamsport, PA (US)

(72) Inventors: Amy TANKERSLEY, Baltimore, MD (US); Paul REEDER, Worthington, OH (US); Erika BRAUN, Columbus, OH (US); George CAMPBELL, San Pedro, CA (US); Jennifer GOFF, Williamsport, PA (US)

(73) Assignee: 180S, INC., Baltimore, MD (US)

(21) Appl. No.: 13/565,465

(22) Filed: Aug. 2, 2012

Related U.S. Application Data
(60) Provisional application No. 61/514,467, filed on Aug. 2, 2011.

(51) Int. Cl. H04R 1/10

(52) U.S. Cl. CPC H04R 1/1075
USPC 381/378

(57) ABSTRACT

An adjustable ear warmer is disclosed. The ear warmer has a band and ear members coupled to the band. The band and the ear members are slidably coupled so that the band and the ear members can move relative to each other. In one embodiment, the ear warmer has headphones that are removably coupled to the ear members.

### CROSS REFERENCE TO OTHER APPLICATIONS

This application claims priority benefit of U.S. provisional application No. 61/514,467, filed Aug. 2, 2011, which is incorporated by reference herein in its entirety.

### BACKGROUND OF THE INVENTION

This invention relates generally to an ear warmer. More specifically, the present invention relates to an adjustable ear warmer and methods of making and assembling an adjustable ear warmer.

### SUMMARY OF THE INVENTION

In one embodiment, an ear warmer includes a band configured to be disposed around a portion of a user's head, the band having a first band member and a second band member, the first band member being separate from the second band member; a first ear portion coupled to the first band member and to the second band member; and a second ear portion coupled to the first band member and to the second band member, the first ear portion and the second ear portion maintaining the first band member and the second band member substantially parallel to each other and in a non-contacting arrangement.

In one implementation, the first ear portion is slidably coupled to the first band member and to the second band member.

In another implementation, the first ear portion includes a first slot and a second slot, the first slot receives the first band member, and the second slot receives the second band member.

In another implementation, the first ear portion includes a first plate and a second plate, the first plate being coupled to the second plate with a portion of the first band member and a portion of the second band member located therebetween.

In another embodiment, an ear warmer comprises a band configured to be disposed around a portion of a user's head; a first ear portion coupled to the band, the first ear portion having an outer surface; and a second ear portion coupled to the band, the second ear portion having an outer surface, at least one of the first ear portion or the second ear portion including a mounting opening formed in its outer surface, the mounting opening being configured to receive a headphone that can receive a signal from an external electronic device.

In one implementation, the headphone includes an engagement member, the first ear portion includes the mounting opening formed in its outer surface, and the first portion includes its own engagement member proximate to the mounting opening, the engagement members cooperating to couple the headphone to the first ear portion.

In another implementation, the ear warmer includes a cover configured to be removably mounted in the mounting opening.

In another implementation, the first ear portion has the mounting opening and a channel extending through the first ear portion, the mounting opening being aligned with the channel.

In another embodiment, an ear warmer comprises a band configured to be disposed around a portion of a user's head; a first ear portion coupled to the band, the first ear portion defining a receptacle or cavity into which a first insulator can be inserted by a user; and a second ear portion coupled to the band, the second ear portion defining a receptacle or cavity into which a second insulator can be inserted by a user.

In one implementation, the receptacle of the first ear portion is located on an inside portion of the first ear portion.

In another implementation, the first ear portion includes a body that receives an end of the band, the body including a cushion member, such as a pad coupled thereto, the cushion member being engageable with the user's head, the receptacle being located between the end of the band and the cushion member.

In another implementation, the first finsulator provides insulation for an ear of the user proximate to the first ear portion.

### BRIEF DESCRIPTION OF THE DRAWINGS

FIG. 1 is a side view of an embodiment of an ear warmer according to the present invention.

FIG. 2 is a side view schematic diagram of the ear warmer illustrated in FIG. 1.

FIG. 3 is a rear perspective view of the ear warmer illustrated in FIG. 1.

FIGS. 4 and 5 are side views of a headphone configured to be used with the ear warmer illustrated in FIG. 1.

FIG. 6 is a side view of another embodiment of an ear warmer according to the present invention.

FIG. 7 is an exploded perspective view of the ear warmer illustrated in FIG. 6.

FIG. 8 is an exploded perspective view of another embodiment of an ear warmer according to the present invention.

FIG. 9 is a side view of the ear warmer illustrated in FIG. 8 with the support coupled thereto.

FIG. 10 is a side view of different uses of the ear warmer illustrated in FIG. 8.

FIG. 11 is an exploded rear perspective view of another embodiment of an ear warmer according to the present invention.

FIG. 12 is another exploded rear perspective view of the ear warmer illustrated in FIG. 11.

FIG. 13 is an exploded front perspective view of the ear warmer illustrated in FIG. 11.

FIG. 14 is an exploded rear view of the ear warmer illustrated in FIG. 11.

FIG. 15 is an exploded front view of the ear warmer illustrated in FIG. 11.

Like reference numerals have been used to identify like elements throughout this disclosure.

### DETAILED DESCRIPTION

An ear warmer according to the present invention can be worn on the head of a user. The ear warmer is configured to cover the wearer's ears to provide comfort as well as warmth and protection from the elements. In one use, the ear warmer is worn so that a frame of the ear warmer extends around the back of the user's head. In another use, the frame of the ear warmer extends around the top of the user's head. The ear warmer includes ear members that are located so as to cover the ears of the user or wearer of the ear warmer. The ear members can be referred to alternatively as ear frame members, ear frame portions, or ear portions.

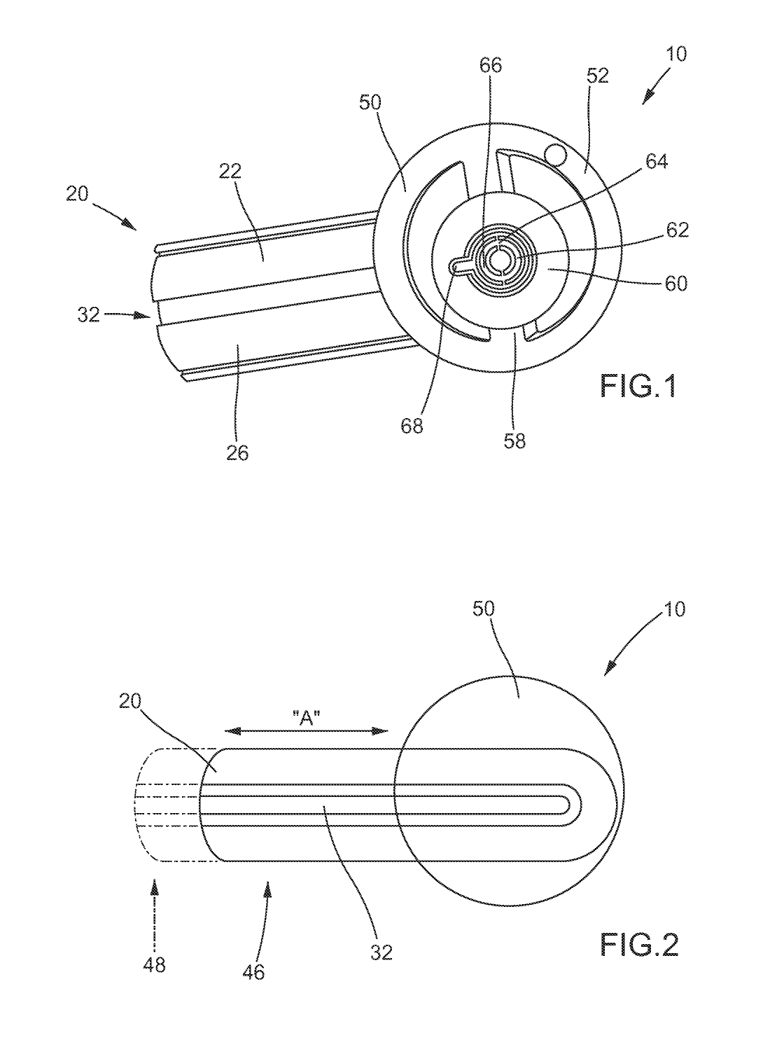

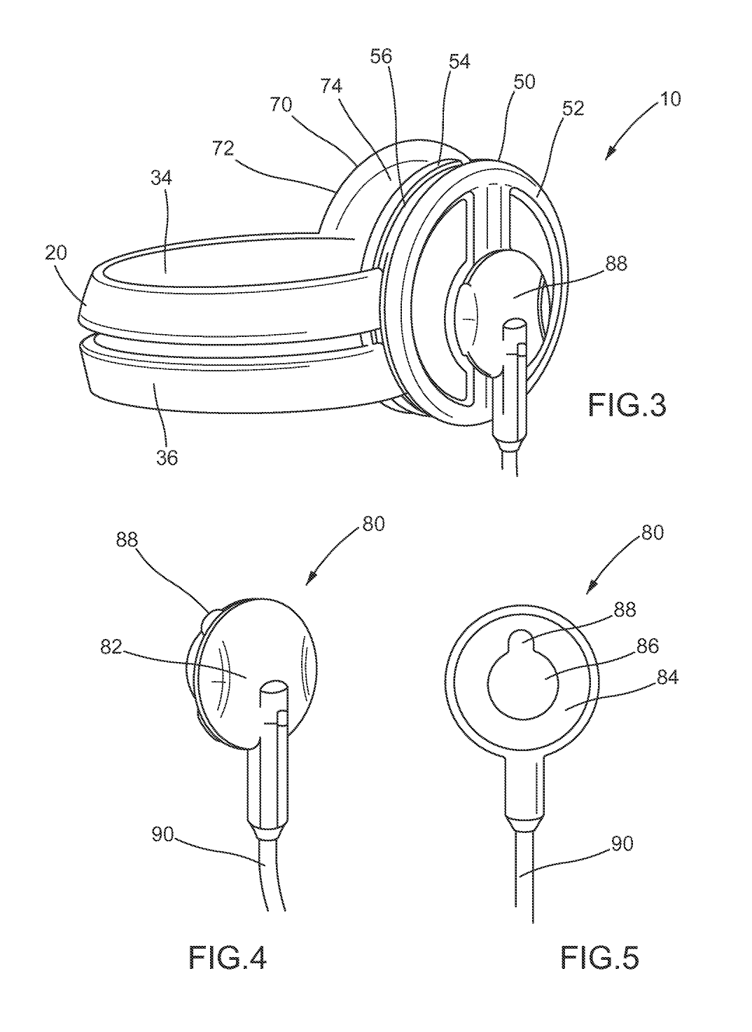

An embodiment of an ear warmer according to the present invention is illustrated in FIGS. 1-5. In this embodiment, ear warmer 10 includes a band 20 and ear members 50 and 70 (see FIG. 3). The ear members 50 and 70 are coupled to the band 20. The band 20 is configured to be disposed around the back of a user's head and/or neck. The band 20 is constructed, in terms of materials used and dimensions, to provide an inwardly biased force on the ear members 50 and 70 to direct them toward each other, thereby applying pressure and a clamping force on the user's head. The forces are used to retain the ear warmer 10 in engagement with the user's head. In one embodiment, the band can be formed of a plastic material. In another embodiment, the band can be formed of a metal material.

Referring back to FIG. 1, the band 20 includes band members or portions 22 and 26 that extend substantially parallel to each other and define a slot 32 therebetween. The ear members 50 and 70 are slidably connected to the band 20, and in particular to band portions 22 and 26, and can move relative thereto. The ear members 50 and 70 maintain the band members 22 and 26 substantially parallel to each other and in a non-contacting arrangement. Referring to FIG. 2, a schematic diagram of the ear warmer 10 is illustrated. As shown, the slot 32 of the band 20 permits relative movement between ear member 50 and the band 20. The band 20 can move relative to the ear member 50 along the directions of arrows “A” and can be placed in different positions 46 and 48 (illustrated in phantom) to adjust the overall length of the ear warmer 10. Ear member 70 moves in a similar manner.

Referring back to FIG. 1, in this embodiment, the ear member 50 includes an outer portion 52 that has a frame 58 with a mount or mounting portion 60 coupled thereto. The mount 60 includes an inner edge 62 that defines an opening 64 to a cavity or receptacle or channel 66 that extends into and through the frame 58. A portion of the edge 62 defines a notch 68, the function of which is described in detail with respect to FIGS. 3-5.

Referring to FIG. 3, a perspective view of the ear warmer 10 is illustrated. The band 20 has an inner surface 34 that is directed toward the user's head when the ear warmer 10 is placed on the user's head and an outer surface 36 that is directed away from the user's head. In addition to the outer portion 52, the ear member 50 includes an inner portion 54 that with outer portion 52 defines an area 56 therebetween. An end of the band 20 is configured to extend into the area 56 between outer portion 52 and inner portion 54, which can be defined by one or more slots. Ear member 70 has a similar construction to ear member 50 in that it includes an outer portion 72 and inner portion 74 that collectively define an area therebetween.

As shown in FIG. 3, a headphone 80 can be mounted to the ear warmer 10. In this embodiment, headphones are removably mounted to ear members. The headphone 80 is located so that audible outputs from the headphone 80 can be heard by the user wearing the ear warmer 10. Ear member 50 includes an opening formed therein that permits output from the headphone 80 to pass through the ear member 50 to the corresponding ear of the user. Ear member 70 includes a similarly formed opening that permits output from another headphone to pass through ear member 70. As discussed below, the headphones are removable from the ear members as desired.

Referring to FIGS. 4 and 5, an embodiment of a headphone 80 is illustrated. The headphone 80 is connectable to an electronic device via a wire 90 that is connected to the body of the headphone 80. As shown, the headphone 80 has an outer surface 82 and an inner surface 84. Coupled to the inner surface 84 is a projection 86 that can be inserted into the opening 64 of the mount 60 on the ear member 50. To mount the headphone 80 to the ear member 50, the projection 86 includes an extension 88 that can be aligned with the notch 68 when the projection 86 is inserted into opening 64. The headphone 80 is rotated approximately 90 degrees to the position illustrated in FIG. 3, which results in the extension 88 moving beneath a portion of the frame 58 and not in alignment with the notch 68. The headphone 80 is then retained in the illustrated position via friction between the headphone 80 and the ear member 50. To remove the headphone 80, the headphone 80 can be rotated in an opposite direction and decoupled when extension 88 is aligned with notch 68.

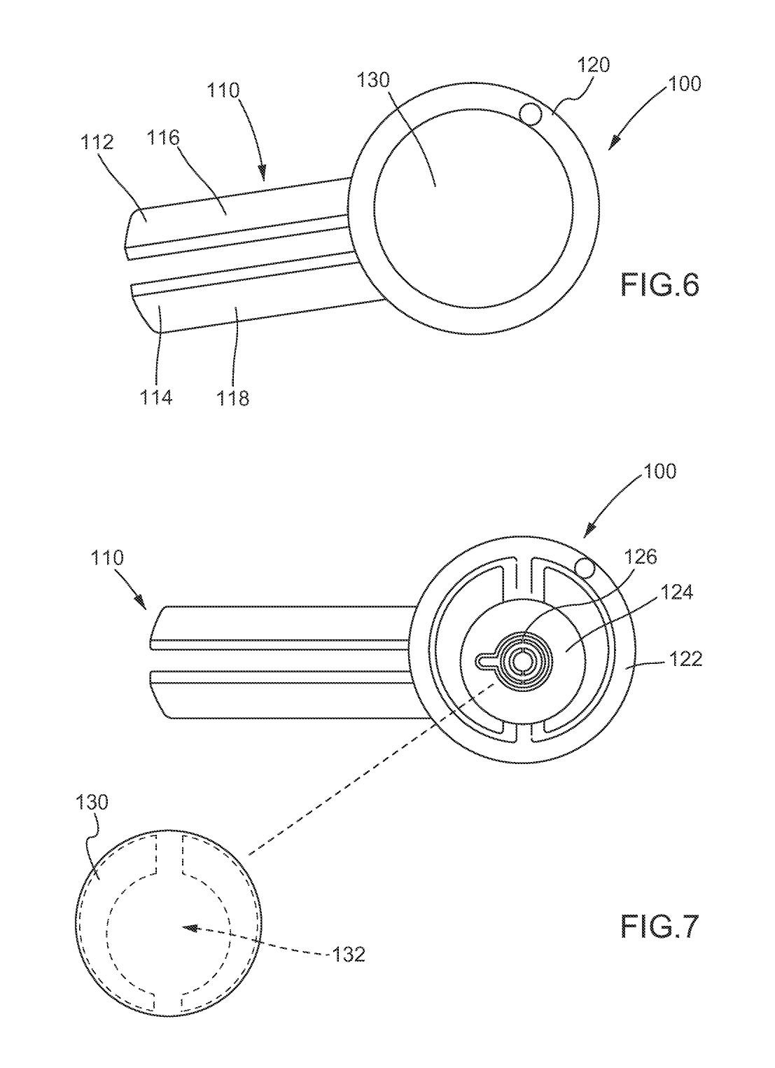

Referring to FIGS. 6 and 7, an alternative embodiment of an ear warmer according to the present invention is illustrated. In this embodiment, the ear warmer 100 includes a band 110 and two ear members (only ear member 120 is illustrated for simplicity). The band 110 includes two band portions 112 and 114 that extend substantially parallel to each other. The band portions 112 and 114 have covers 116 and 118 thereon, respectively, that extend along the lengths of the band portions 112 and 114.

In one implementation, the covers 116 and 118 can be removable from the band portions 112 and 114 so that a user can interchange the different covers to customize and change the overall appearance of the ear warmer 100. For example, covers 116 and 118 can be made of leather. Other covers can be made of different materials, such as different fabrics.

As shown in FIG. 7, the ear member of ear warmer 100 includes a frame 122 with a mount 124 that defines an opening 126 in a manner similar to ear member 50 described above. In this embodiment, a cap 130 can be mounted to the frame 122. The cap 130 includes a mounting portion 132 (shown in phantom) that permits the cap 130 to be removably coupled to the frame 122 and the outer surface of the ear member 120. The removability of the cap 130 enables any one of a variety of caps to be coupled to the ear member 120, thereby facilitating the customizing of the ear warmer 100. In different embodiments, the materials of the ear warmer can vary. For example, the frame 122 can be made of stainless steel.

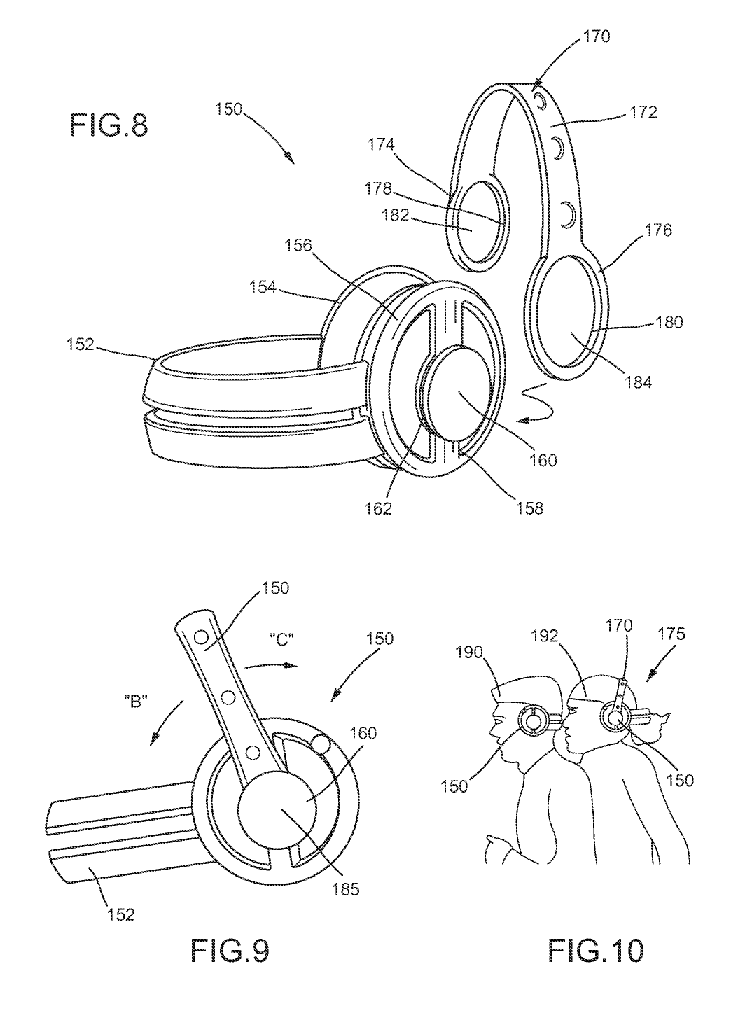

Referring to FIGS. 8-10, another embodiment of an ear warmer according to the present invention is illustrated. In this embodiment, the ear warmer 150 includes a band 152 and two ear members 154 and 156 coupled to opposite ends of the band 152. The ear members 154 and 156 are similarly constructed.

Ear member 156 has a frame with an outer surface 158 that includes a protrusion or mount 160. The mount 160 extends outwardly from the frame of the ear member 152 as shown. The mount 160 has an outer edge 162 that defines the perimeter of the mount 160.

A support 170 is removably coupleable to the ear warmer 150 and can be used for additional support of the ear warmer 150 on the head of a user as illustrated in FIG. 10. Referring back to FIG. 8, the support 170 includes a central portion 172 and opposite ends 174 and 176. The ends 174 and 176 define mounting portions that have edges 178 and 180 that define openings 182 and 184, respectively. The support 170 is formed of a resilient, elastic material, such as rubber. As a result, the mounting portions can be stretched so that the mount on each ear member is inserted into a corresponding opening of the support 170 to couple the support 170 to the ear warmer 150. For example, mounting portion 177 can be stretched so that edge 180 is extended over the edge 162 of the mount 160 and then released. When the support 170 is coupled to the ear warmer 150, the mount 160 extends through opening 184 and the mount on ear member 154 extends through opening 182.

When the support 170 is coupled to the ear warmer 150, the support 170 can pivot about axis 185 along the directions of arrows “B” and “C” (see FIG. 9). The support 170 can be pivoted along the direction of arrow “C” to an upright position as illustrated in FIG. 10 so that the support 170 can engage the top of the head of a user. When support over the top of the user's head is not desired, the support 170 can be rotated along the direction of arrow “B.”

Referring to FIG. 10, users 190 and 192 are wearing ear warmers 150. The ear warmer 150 of user 192 has its support 170 rotated to its supporting position 175 that enables it to engage the top of the head of the user.

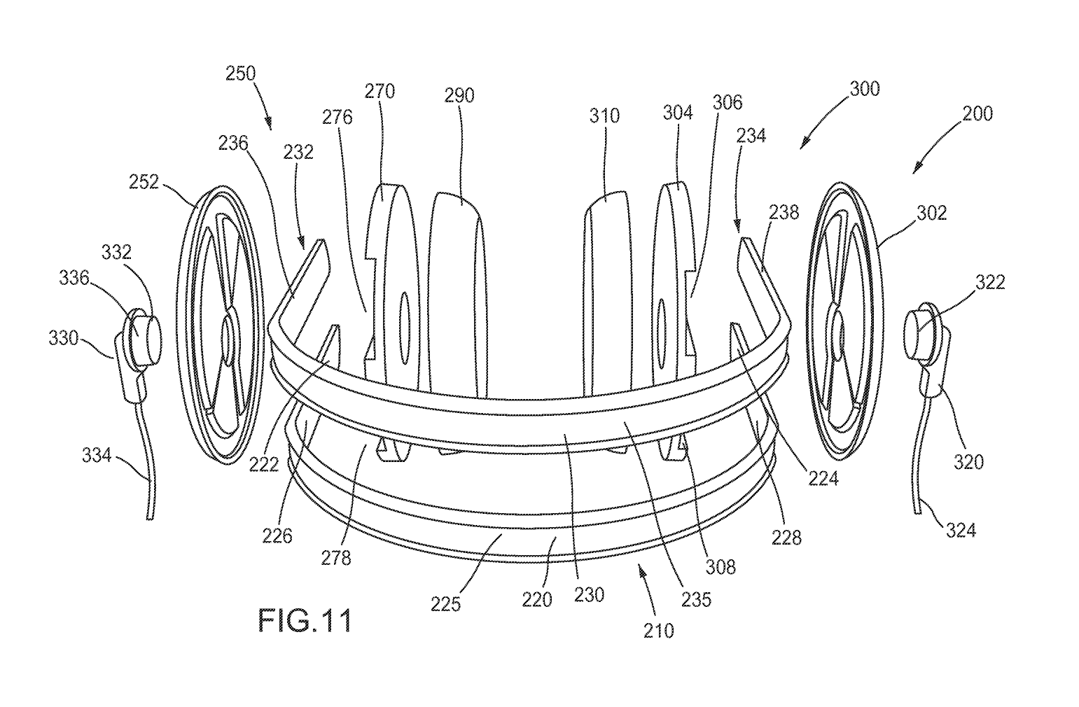

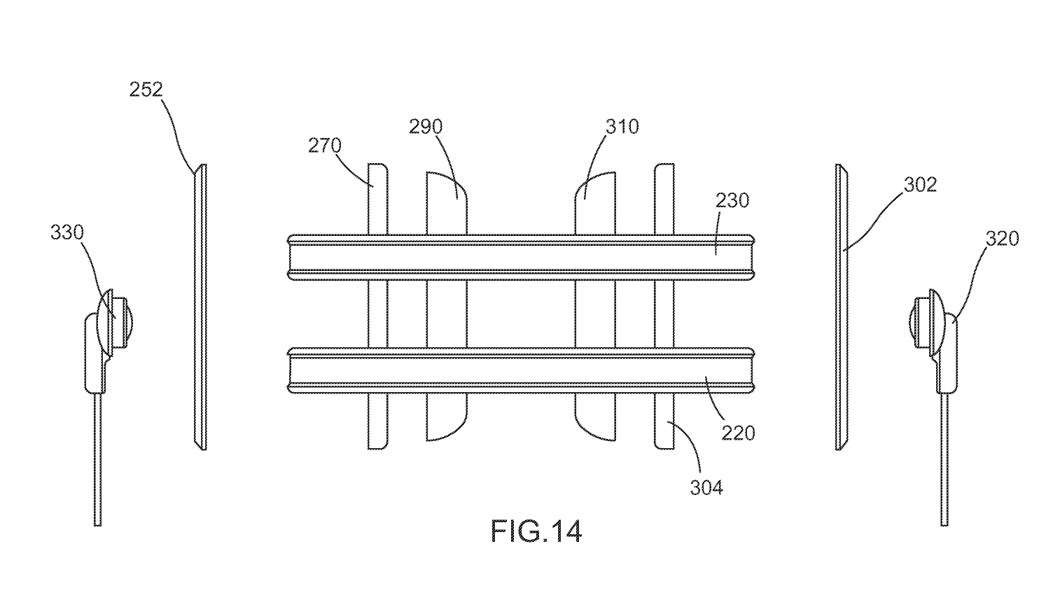

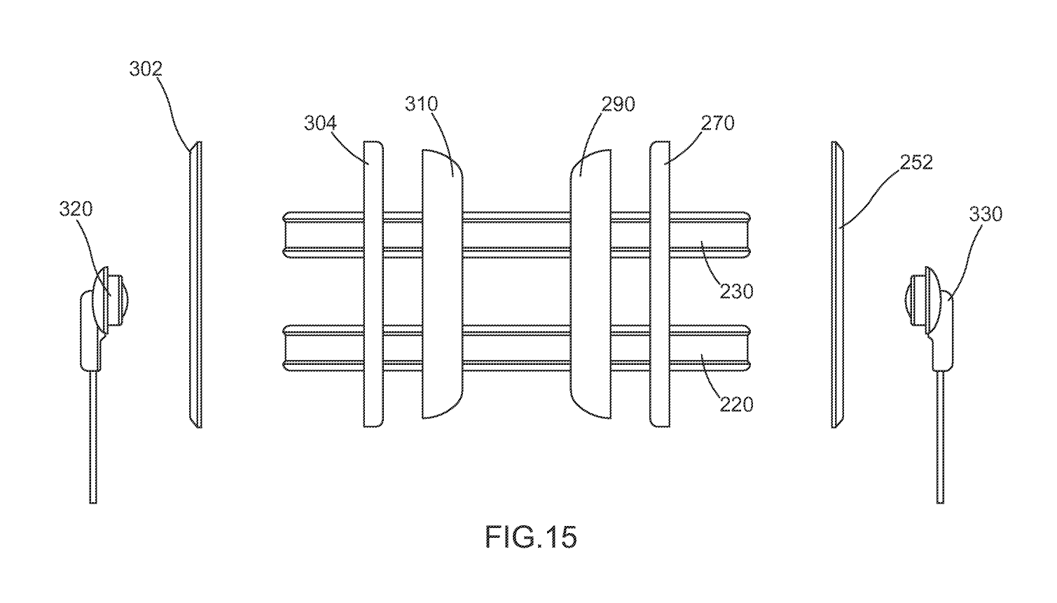

Referring to FIGS. 11-15, an alternative embodiment of an ear warmer according to the present invention is illustrated. In this embodiment, the ear warmer 200 includes a band 210 and ear members 250 and 300 that are coupled to the band 210. Referring to FIG. 11, the band 210 includes two band portions 220 and 230 that extend parallel to each other. The band 210 can be formed of plastic, metal, or any other material that has sufficient to maintain the ear warmer in a desired position and orientation on a user.

Band portion 220 is an elongate member with opposite ends 222 and 224. Band portion 220 includes a curved portion 225 located generally in the middle or center of the band portion 220 and linear portions 226 and 228 proximate to ends 222 and 224, respectively. Similarly, band portion 230 is an elongate member with opposite ends 232 and 234 with a central curved portion 235 and linear portions 236 and 238 proximate to ends 232 and 234, respectively.

Ear member 250 is slidably coupled to the band portions 220 and 230. Ear member 250 includes an outer portion or plate 252 and an inner portion or plate 270 that are coupled together, such as by using an adhesive or welding. The inner portion 270 includes a pair of slots or grooves 276 and 278 formed therein. When the outer portion 252 and the inner portion 270 are coupled together, the slots 276 and 278 remain accessible. The linear portions 226 and 236 of band portions 220 and 230 are inserted into the slots 278 and 276, respectively. As a result, the ear member 250, and in particular, the outer portion 252 and the inner portion 270, can slide along the linear portions 226 and 236, thereby permitting adjustment of the band 210 and the ear member 250 relative to each other.

Ear member 250 also includes a cushion member 290, such as a pad, that is coupled to the inner side of the inner portion 270. The cushion member 290 provides a comfortable surface for contacting the head of the user. In one embodiment, the cushion member 290 is mounted to inner portion 270 so that a gap is formed therebetween. A piece of insulation, such as fabric or other material can be inserted into the receptacle or gap between the cushion member 290 and the inner portion 270 by a user. The inserted piece of material is an additional barrier between the user's ear and the elements, thereby providing additional protection for the user. The inserted piece of material can be inserted and removed as desired by the user. For example, the material can be inserted to increase the warmth of the ear warmer 200. If the additional warmth is not desired, the material can be removed.

In one implementation, the cushion member 290 can be mounted to the inner portion 270 via one or more stand-offs that provide a gap between the cushion member 290 and the inner portion 270. Alternatively, the outer surface or side of the cushion member 290 can have a groove or slot formed therein that defines the receptacle or gap between the cushion member 290 and the inner portion 270. The groove or slot has one or more openings that allow access to the inner portion 270. The piece of material can be inserted through the opening. In one implementation, the opening of the groove or slot is located on an upper side of the ear warmer 200.

Similarly, ear member 300 is slidably coupled to the band portions 220 and 230. Ear member 300 includes an outer portion or plate 302 and an inner portion or plate 304 that are coupled together. The inner portion 304 includes a pair of slots or grooves 306 and 308 formed therein. When the outer portion 302 and the inner portion 304 are coupled together, the linear portions 228 and 238 of band portions 220 and 230 are inserted into and are slidable within the slots 308 and 306, respectively. As a result, the ear member 300 can slide along the linear portions 228 and 238, thereby permitting adjustment of the band 210 and the ear member 300 relative to each other.

Ear member 300 also includes a cushion member 310 that is coupled to the inner side of the inner portion 304. Like cushion member 290, cushion member 310 is mounted to inner portion 304 so that a receptacle or gap is formed therebetween. A piece of fabric or other material can be inserted into the gap between the cushion member 310 and the inner portion 304 by a user. The inserted piece of material is an additional barrier between the user's ear and the elements, thereby providing additional protection for the user. The inserted piece of material can be inserted and removed as desired by the user.

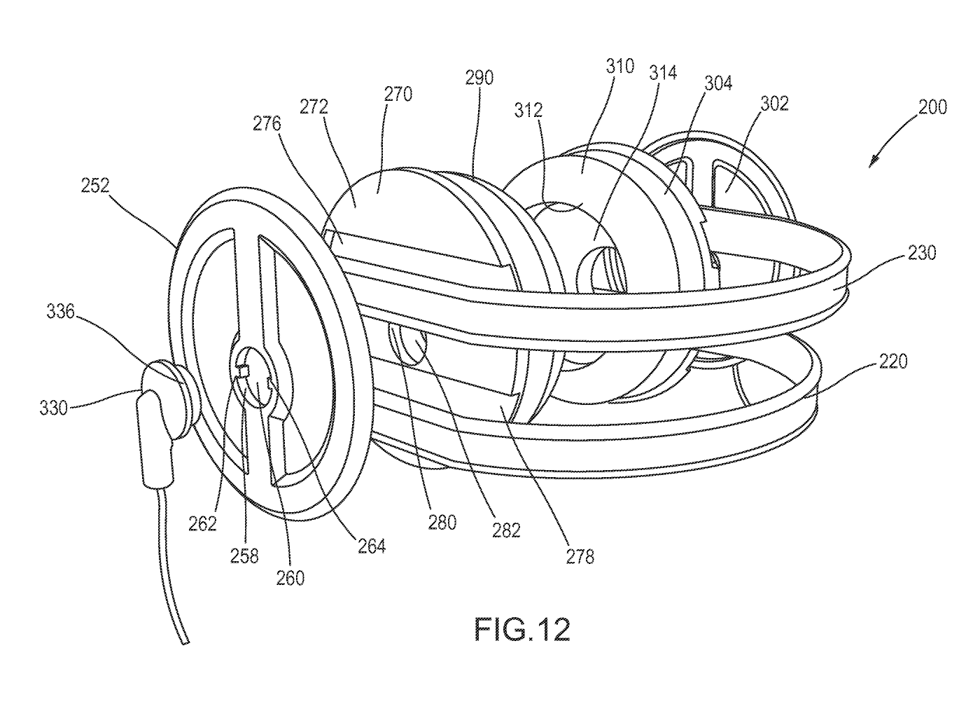

As illustrated in FIG. 11, headphones 320 and 330 can be coupled to the ear warmer 200. Headphone 330 includes a mounting portion 332 that is coupled to ear warmer 250 as described below relative to FIG. 12. The mounting portion 332 includes one or more engagement members (such as protrusions, recesses, or notches 336) formed therein. Headphone 330 also includes a wire 334 that is connected to an electronic device. Similarly, headphone 320 includes a mounting portion 322 that is coupleable to ear member 300 and a wire 324 that is connected to the electronic device.

Referring to FIG. 12, a different perspective view of the ear warmer 200 is illustrated. The slots 276 and 278 in the outer side 272 of the inner portion 270 are visible in this view. The band portions 220 and 230 are illustrated in the positions relative to the slots 276 and 278.

The inner portion 270 also includes an inner edge 280 that defines an opening 282 through the inner portion 270. The opening 282 is centrally located in this embodiment and has a circular shape. In different embodiments, the shape and size of the opening can vary. The opening 282 is aligned with the opening formed in the cushion member 290.

The outer portion 252 includes an inner edge 258 that defines an opening 260 that extends through the outer portion 252. The edge 258 includes a pair of engagement members or tabs 262 and 264 that extend inwardly into the opening 260. The tabs 262 and 264 engage the notches 336 in headphone 330 to secure the headphone 330 to ear member 250. In some embodiments, the opening 260 can include a slot and/or a projection configured to retain a corresponding feature of the headphone 330.

As mentioned above, one or more layers of fabric or other material may be located between the cushion member 290 and the inner portion 270 to provide a barrier to cold air passing through openings 260 and 282 to a user's ear. Alternatively, one or more layers of fabric or other material may be located between the outer portion 252 and the inner portion 270.

Referring to FIG. 12, the components of the other ear member are also illustrated. The outer portion 302, inner portion 304, and the cushion member 310 are shown. The cushion member 310 includes an inner edge 312 that defines an opening 314 that extends through the cushion member 310.

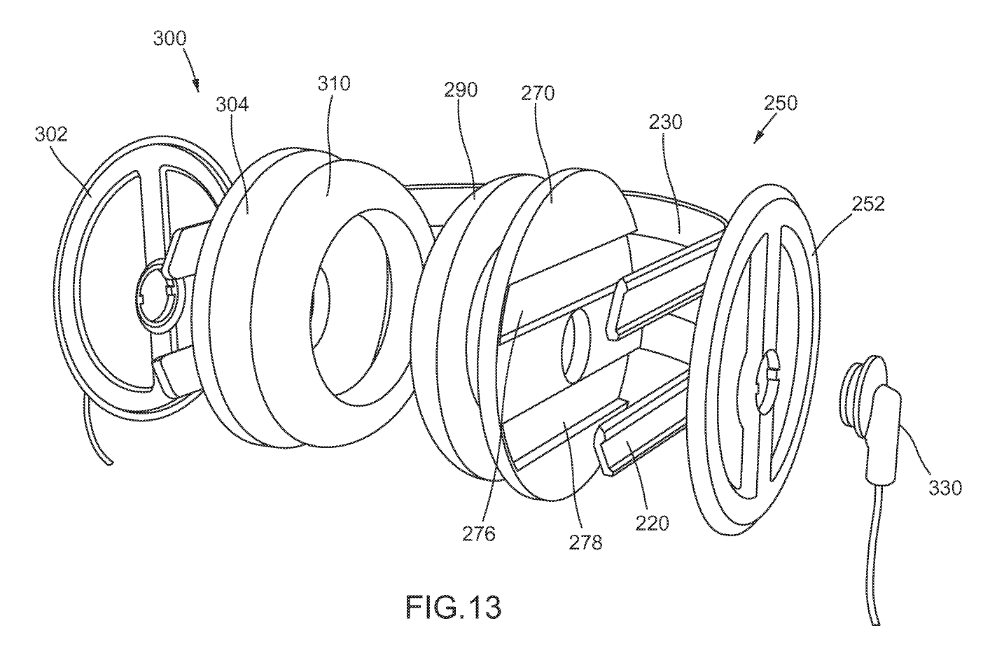

Referring to FIGS. 13-15, additional views of the components of ear warmer 200 are illustrated. In these views, the relative positions of the ear members 250 and 300 are shown. The assembled outer portion 302, inner portion 304, and cushion member 310 are slidable on the band portions 220 and 230. Similarly, the assembled outer portion 252, inner portion 270 (with slots 276 and 278), and cushion member 290 are slidable on the band portions 220 and 230. The removable headphones 320 and 330 are also illustrated.

In an alternative embodiment, the band 210 and the ear members 250 and 300 can be covered by one or more pieces of material that form a shell defining an interior into which at least a portion of the band 210 or the ear members 250 and 300 may be inserted.

The disclosures of the following U.S. patents are hereby incorporated by reference in their entirety for all purposes: U.S. Pat. Nos. 5,835,609, 6,332,223, 6,499,146, 6,502,247, 6,502,248, 6,735,784, 7,212,645, 7,650,649, and 7,963,970.

While the invention has been described in detail and with references to specific embodiments thereof, it will be apparent to one skilled in the art that various changes and modifications can be made therein without departing from the spirit and scope thereof. Thus, it is intended that the present invention covers the modifications and variations of this invention.

What is claimed is:

1. An apparatus comprising:
a band;
a first ear portion coupled to the band, the first ear portion defining at least a portion of a mount, the mount configured to receive a headphone therein;
the mount including a receiving portion and a retention portion, the receiving portion configured to receive the headphone when the headphone is in a first orientation, the retention portion configured to retain the headphone in the first ear portion when the headphone is in a second orientation; and
a second ear portion coupled to the band.

2. The apparatus of claim 1, wherein the first ear portion defines an opening, the receiving portion including a notch adjacent the opening, the notch configured to receive a protrusion of the headphone.

3. The apparatus of claim 1, wherein the first ear portion defines an opening, the retention portion including a slot adjacent the opening, the slot configured to receive a protrusion of the headphone when the headphone is in the second orientation.

4. The apparatus of claim 1, further comprising the headphone, the headphone having a protrusion configured to be adjacent the receiving portion when the headphone is in its first orientation and be adjacent the retention portion when the headphone is in its second orientation.

5. The apparatus of claim 4, wherein the headphone is configured to rotate within the mount between the first orientation and the second orientation.

6. The apparatus of claim 1, the band being a first band, the mount being a first mount, the apparatus further comprising:
a second mount coupled to the first ear portion; and
a second band configured to be removably coupled to the second mount.

7. The apparatus of claim 1, further comprising:
a pad configured to be coupled to an inner surface of the first ear portion, the pad and the inner surface defining a cavity therebetween and defining an access opening in communication with the cavity; and
an insulator configured to be removably disposed within the cavity via the access opening.

8. The apparatus of claim 1, wherein the first ear portion is slidably coupled to the band.

9. An apparatus comprising:
a band;
a first ear portion having an inner portion and an outer portion, the inner portion coupled to the outer portion;
at least one of an outer surface of the inner portion or an inner surface of the outer portion defining a groove, the band configured to be slidably disposed in the groove when the inner portion is coupled to the outer portion;
the outer portion having at least a portion of a mount, the mount configured to receive a portion of a headphone; and
a second ear portion coupled to the band.

10. The apparatus of claim 9, further comprising:
a pad coupled to the inner portion of the first ear portion.

11. The apparatus of claim 9, wherein the mount includes a receiving portion and a retention portion, the receiving portion configured to receive the headphone when the headphone is in a first orientation, the retention portion configured to retain the headphone in the first ear portion when the headphone is in a second orientation.

12. The apparatus of claim 9, wherein the mount includes an extension and the headphone includes a corresponding notch, the notch and the extension configured to cooperate to removably couple the headphone to the first ear portion.

13. The apparatus of claim 9, the band being a first band, the groove being a first groove, the apparatus further comprising:
a second band configured to be slidably disposed in a second groove defined between the inner portion and the outer portion.

14. The apparatus of claim 9, further comprising:
a pad configured to be coupled to an inner surface of the first ear portion, the pad and the inner surface defining a cavity therebetween and defining an access opening in communication with the cavity; and
an insulator configured to be removably disposed within the cavity via the access opening.

15. The apparatus of claim 9, wherein the band is configured to apply an inwardly biased force to the first ear portion and the second ear portion when the apparatus is disposed about a head of a user.

16. An apparatus comprising:
a first band;
a first ear member coupled to the first band, the first ear member having a first mount and a second mount, the second mount configured to receive a portion of a headphone;
a second ear member coupled to the first band, the second ear member having a third mount; and
a second band configured to be removably coupled to the first mount and the third mount.

17. The apparatus of claim 16, further comprising:
a cap configured to be coupled to the first mount.

18. The apparatus of claim 16, wherein at least a portion of the second band is constructed of a resilient material.

19. The apparatus of claim 16, wherein the second band is configured to be rotatably coupled to the first mount and the third mount, such that the second band can rotate from a first position adjacent to the first band to a second position spaced apart from the first band.

20. The apparatus of claim 16, wherein the second mount is configured to receive the headphone when the headphone is in a first orientation, and retain the headphone when the headphone is in a second orientation.
